(19) United States
(12) Patent Application Publication
(10) Pub. No.: US 2007/0219747 A1
(43) Pub. Date: Sep. 20, 2007

(54) HDD throttle polling based on blade temperature

(76) Inventors: James E. Hughes, Cary, NC (US); Henry G. McMillan, Raleigh, NC (US); Challis L. Purrington, Raleigh, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/369,559

(22) Filed: Mar. 7, 2006

(51) Int. Cl. G06F 19/00

(52) U.S. Cl. 702/182; 702/127; 702/130; 702/136

(57) ABSTRACT

A method, apparatus and computer-readable medium for adjusting Predictive Failure Analysis (PFA) polling rates based on a temperature of an electronic device is presented. In one embodiment, the method includes the steps of by recognizing the danger that high temperatures pose to the HDD, adjusts PFA polling rates. In one embodiment, the invention includes the steps of setting a maximum temperature at which an electronic device (for example, a hard disk drive) can operate without damage; measuring a temperature of the electronic device; and increasing a frequency of Predictive Failure Analysis (PFA) operations as the temperature of the electronic device approaches the maximum temperature. The PFA operations include, but are not limited to, polling performance data that is being collected in real-time for the electronic device.

### BACKGROUND OF THE INVENTION

1. Technical Field

The present invention relates in general to the field of computers and similar technology systems, and in particular to mass storage devices associated with such technology systems. Still more particularly, the present invention relates to a method for controlling how often a Hard Disk Drive (HDD) is polled for Predictive Failure Analysis (PFA) alerts according to a temperature of a blade on which the HDD is mounted.

2. Description of the Related Art

Modern computers rely on a memory hierarchy for storing data and programs. The highest level (closest to execution units that are within a processor core used in the computer) of data is that found in registers, followed (in hierarchy level and decreasing retrieval speed) by cache memory, system memory, and mass storage memory. The most common type of mass storage memory is a Hard Disk Drive (HDD), which is made up of one or more platters that store data. Such data are stored by read/write heads that magnetize tiny areas on spinning (rotating) platters. These tiny areas represent ones and zeros that make up binary bits of data that are used by the computer. The read/write heads float above the platters on a thin cushion of air that is generated by the rotation of the platters. If the platters should stop spinning while the head is over a sensitive area (i.e., a writable area that is not designated as a head parking area on the platter), the head will “crash” into the platter, causing permanent mechanical damage to the head and possibly the platter.

To predict if and when a HDD will fail (due to a head crash, power failure, software failure, etc.), many HDD systems utilize Predictive Failure Analysis (PFA). PFA predicts failures to HDD systems either by the use of error logs (symptom driven) or Generalized Error Measurements (GEM) (measurement driven). Usage of error logs and GEM are similar in nature, but differ somewhat in application. Error logs are the output of data, non-data and motor start error recovery logs. An analysis of these logs by PFA is performed periodically during idle periods in which the HDD is not actively being written to or read from. These logs provide a history that, when compared to other histories that preceded an HDD failure, can be used to predict a failure of the current HDD operation. Similarly, GEM automatically performs a suite of self-diagnostic tests that measure any changes to the operation of the HDD. These tests use real-time measurements of head flying height (distance between the read/write had and the platter), signal coherence, channel noise, etc. These measurements are then compiled to predict a failure of the HDD operation. This prediction is not history-based, but rather is performance based.

Typically, the execution of PFA routines (including polling of logs, sensors, etc.) is on a static timetable. That is, PFA routines are executed at pre-determined time intervals (in the case of GEM), or only during idle periods (in the case of error log analysis). When setting the pre-determined time intervals (or deciding whether to wait for a next idle period or to poll error logs sooner), a balance must be struck between safety and performance. Thus, if PFA routines are run too often, then HDD performance is degraded, since the HDD is busy running PFA routines rather than reading/writing normal program data. Conversely, if the PFA routines are run too infrequently, then a fatal condition may occur before that fatal condition can be predicted and avoided by the PFA.

### SUMMARY OF THE INVENTION

To address the problem described above, an improved method, apparatus and computer-readable medium for controlling a Predictive Failure Analysis (PFA) is presented.

For various reasons, the operation of a Hard Disk Drive (HDD) is very sensitive to high temperatures. High temperatures can cause, among other problems, head flying height to change to the point that either a read/write head is too far away from the platter to accurately record bits of data, or else the read/write head may be too close to the platter, resulting in a crash of the read/write head against the spinning platter. Likewise, high temperatures can cause erratic electronic signal production, both to control signals as well as data signals.

Thus, the present invention, by recognizing the danger that high temperatures pose to the HDD, adjusts PFA polling rates according to how hot an HDD or an associated blade environment is. In one embodiment, the invention includes the steps of setting a maximum temperature at which an electronic device (for example, a hard disk drive) can operate without damage; measuring a temperature of the electronic device; and increasing a frequency of Predictive Failure Analysis (PFA) operations as the temperature of the electronic device approaches the maximum temperature. The PFA operations include, but are not limited to, polling performance data that is being collected in real-time for the electronic device.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1a illustrates an exemplary computer system in which the present invention may be implemented;

FIGS. 1b-c depict additional detail of a Hard Disk Drive (HDD) used by the computer system shown in FIG. 1a;

FIG. 1d provides additional detail of components of a Thermal Based Predictive Failure Analysis Program (TBPFAP) that adjusts Predictive Failure Analysis (PFA) polling rates according to blade temperature; and

FIG. 2 is a flow-chart showing exemplary steps taken to adjust PFA polling rates upwards as the blade temperature increases.

### DETAILED DESCRIPTION OF THE PREFERRED EMBODIMENT

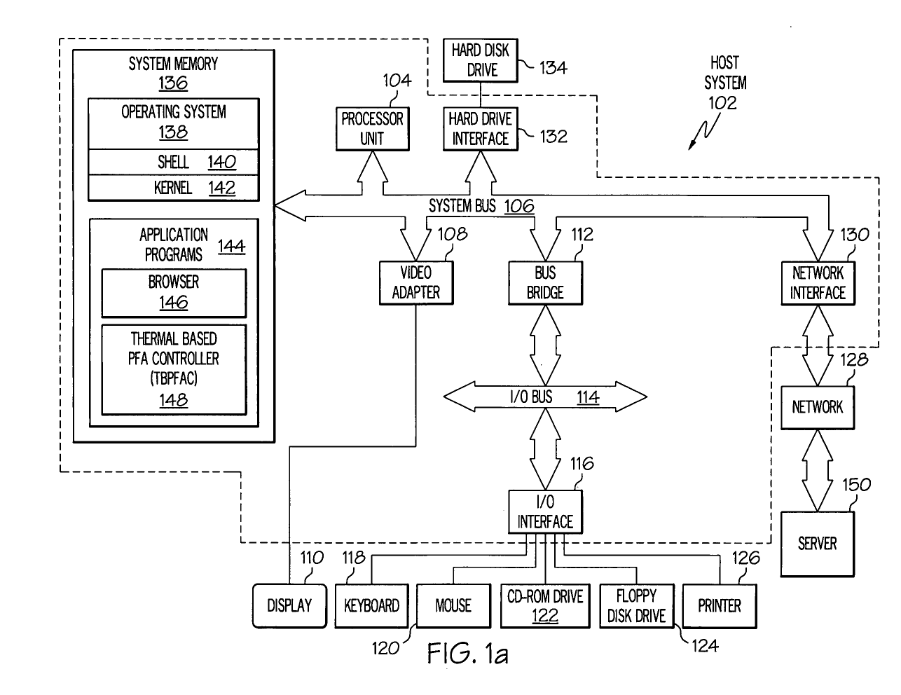

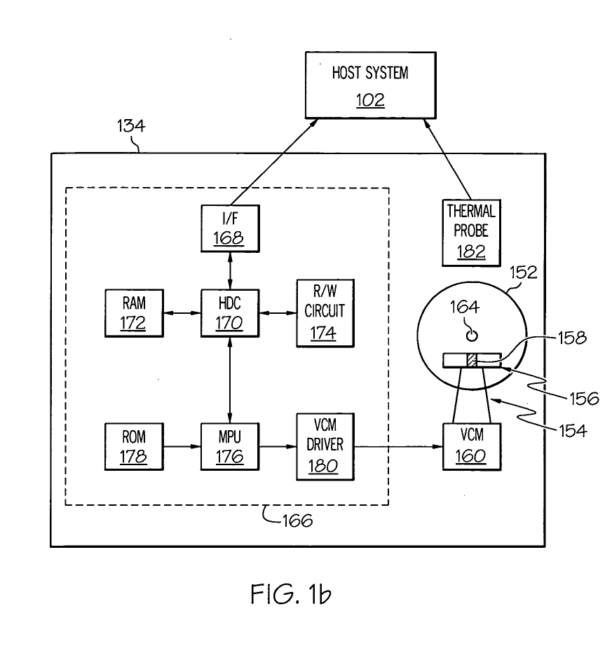

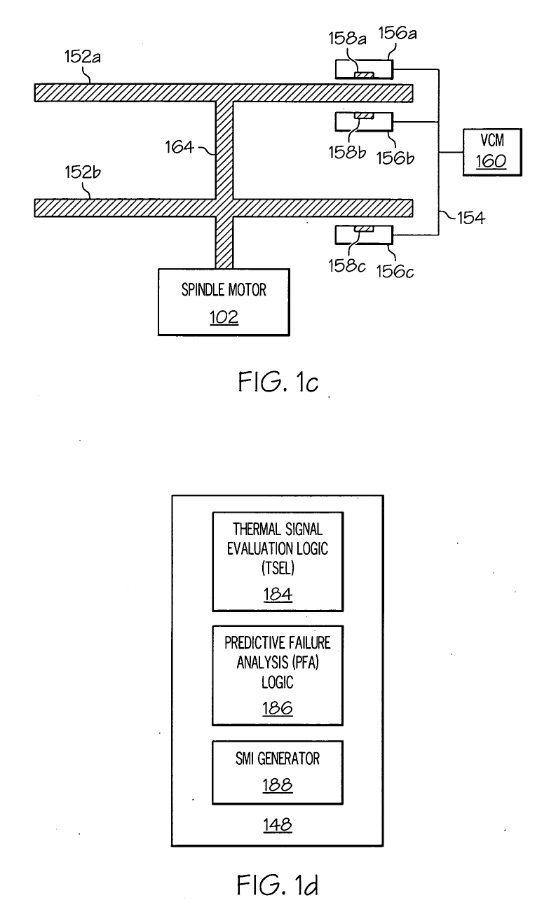

With reference now to the figures, and in particular to FIG. 1, there is depicted a block diagram of an exemplary host system 102 in which the present invention may be utilized. In a preferred embodiment, host system 102 is a blade server that is part of a blade server system. Host system 102 includes a processor unit 104 (which is preferably a multi-processor system) that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is also coupled to I/O bus 114. I/O interface 116 affords communication with various I/O devices, including a keyboard 118, a mouse 120, a Compact Disk-Read Only Memory (CD-ROM) drive 122, a floppy disk drive 124, and a printer 126. The format of the ports connected to I/O interface 116 may be any known to those skilled in the art of computer architecture, including but not limited to Universal Serial Bus (USB) ports.

Host system 102 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may have a similar architecture as described for host system 102.

A hard drive interface 132 is also coupled to system bus 106. Hard drive interface 132 interfaces with a Hard Disk Drive (HDD) 134. In a preferred embodiment, HDD 134 populates a system memory 136, which is also coupled to system bus 106. Data that populates system memory 136 includes host system 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., host system 102) to send and receive network messages to the Internet using HyperText Transfer Protocol (HTTP) messaging, thus enabling communication with server 150.

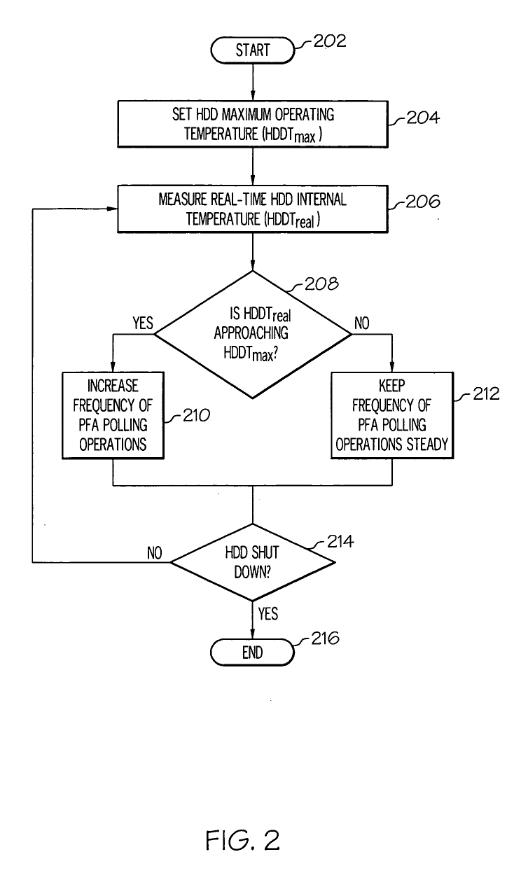

Application programs 144 in host system 102's system memory also include a Thermal Based Predictive Failure Analysis Controller (TBPFAC) 148. TBPFAC 148 includes code for implementing the processes described below in FIG. 2, and includes the data structure represented in exemplary fashion in FIG. 1d. In one embodiment, host system 102 is able to download TBPFAC 148 from server 150. Alternatively, server 150 may perform many or all of the execution of processes found in TBPFAC 148, thus freeing up resources in host system 102.

The hardware elements depicted in host system 102 are not intended to be exhaustive, but rather are representative to highlight essential components required by the present invention. For instance, host system 102 may include alternate memory storage devices such as magnetic cassettes, Digital Versatile Disks (DVDs), Bernoulli cartridges, and the like. These and other variations are intended to be within the spirit and scope of the present invention.

Referring now to FIG. 1b, additional detail of HDD 134 is presented. HDD 134 has a set of hard disks 152, which are rigid platters composed of a substrate and a magnetic medium. Since the substrate is non-magnetic, both sides of each hard disk 152 can be coated with the magnetic medium so that data can be stored on both sides of each hard disk 152. An actuator arm 154 moves a slider 156, which is gimbal mounted to the actuator arm 154. The slider 156 carries a read/write head 158 to a specified lateral position above the surface of the hard disk 152 when a Voice Coil Motor (VCM) 160 swings the actuator arm 154.

With reference now to FIG. 1c, there is depicted additional detail of hard disks 152. Hard disks 152 are a stack of hard disk platters, shown in exemplary form as hard disks 152a-b. Preferably, more than two platters are used, but only two are shown for the sake of clarity. As a spindle motor 162 turns spindle 164, each hard disk 152 connected to spindle 164 rotates at speeds in excess of 10,000 revolutions per minute (RPMs). Each hard disk 152 has two surfaces, one or both of which can be magnetized to store data. Thus, hard disk 152a is able to store data on both sides using read/write heads 158a and 158b. Hard disk 152b stores data on only one side using read/write head 158c. Thus, the system illustrated in FIG. 1c is a two-platter three-head HDD. By swinging the actuator arm 154 (and thus causing the movement of sliders 156 and read/write heads 158) and rotating the spindle 164 (and thus spinning hard disks 152), read/write heads 158 can be positioned above any spot above the surface of the hard disks 152.

Referring again to FIG. 1b, data reads/writes between the host system 102 and magnetic heads 158 are under the control of a controller 166. Controller 166 includes an Interface (I/F) 168 coupled to host system 102. Coupled to I/F 168 is a Hard Disk Controller (HDC) 170, which coordinates read/write operations, and controls modes of operation of HDD 134, including Active Seek and IDLE modes. Coupled to HDC 170 is a Random Access Memory (RAM) 172, which caches data to be read/written to hard disks 152. Read/write circuit 174 includes an Analog-to-Digital Converter (ADC) and a Digital-to-Analog Converter (DAC). The ADC (not shown) is used to convert analog signals into digital signals for reads from the hard disks 152. The DAC (not shown) is used to convert digital values into appropriate analog signals for writes to the hard disks 152. A microprocessor unit (MPU) 176, which is under the control of a micro-program stored in Read Only Memory (ROM) 178, controls a VCM driver 180. VCM driver 180 controls movement of the VCM 160 using a DAC, which converts a digital control signal from MPU 176 into an analog control signal for VCM 160. Typically, VCM driver 180 also works in coordination with a controller (not shown) for spindle 162, to provide proper positioning of read/write heads 158 above the surface of hard disks 152 during read/write operations.

As depicted in FIG. 1b, HDD 134 includes a thermal probe 182. Alternatively, thermal probe 182 may be mounted proximate to host system 102 (on the server blade board). By measuring the ambient temperature in or around HDD 134, TBPFAC 148 is able to increase the frequency of Predictive Failure Analysis (PFA) operations as the ambient temperature rises, as described below in FIG. 2.

Referring now to FIG. 1d, additional detail is presented for TBPFAC 148. A Thermal Signal Evaluation Logic (TSEL) 184 measures the temperature of either the blade that is host system 102, or more directly, HDD 134. Predictive Failure Analysis (PFA) Logic 186 performs the PFA functions described above. When PFA Logic 186 determines that a PFA function, such as polling PFA logs or fault sensors within HDD 134, need to be performed more frequently due to an increase in ambient temperature around 134, then a System Management Interrupt (SMI) generator 188 creates an SMI, which causes normal program execution in host system 102 to pause while PFA functions are performed.

Referring now to FIG. 2, a flow-chart of exemplary steps taken by the present invention is presented. After initiator block 202, the maximum operating temperature that an electronic device (e.g., a Hard Disk Drive) can operate without damage to that device is set (block 204). The temperature of that electronic device is them measured (block 206). If the temperature of the electronic device is approaching the maximum operating temperature (query block 208), then the frequency of PFA operations (e.g., polling PFA logs, sensors, etc.) is increased (block 210). Otherwise, the frequency of PFA operations remains steady (block 212). If the electronic device has not shut down (query block 214), then the temperature measurement and comparison continues in an iterative fashion as shown. Otherwise, the process ends (terminator block 216).

Note that by increasing the frequency of PFA operations as HDD temperature nears a dangerous level, there is a greater chance that fatal errors can be detected and corrected. Note also that the temperature that is deemed as “approaching” or “nearing” the maximum safe temperature may be set as either at single fixed point (e.g., 90% the “fatal” temperature), or “nearing” may be broken out into multiple breakpoints. Thus, if the temperature reaches a first breakpoint temperature (e.g., 80% of the “fatal” temperature), then a first frequency of PFA operations may be implemented. When the temperature of the electronic device (e.g., HDD) reaches a second breakpoint temperature (e.g., 90% of the “fatal” temperature), then a higher second frequency of PFA operations may be implemented. In one embodiment, the number of PFA operations increases in a non-linear manner as the temperature of the electronic device approaches the “fatal” (maximum temperature at which the electronic device can operate without damage) temperature.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method comprising:
setting a maximum temperature at which an electronic device can operate without damage;
measuring a temperature of the electronic device; and
increasing a frequency of Predictive Failure Analysis (PFA) operations as the temperature of the electronic device approaches the maximum temperature.

2. The method of claim 1, wherein PFA operations including polling performance data that is being collected in real-time for the electronic device.

3. The method of claim 1, wherein the electronic device is a Hard Disk Drive (HDD).

4. A system comprising:
a processor;
a data bus coupled to the processor;
a memory coupled to the data bus; and
a computer-usable medium embodying computer program code, the computer program code comprising instructions executable by the processor and configured for:
setting a maximum temperature at which an electronic device can operate without damage;
measuring a temperature of the electronic device; and
increasing a frequency of Predictive Failure Analysis (PFA) operations as the temperature of the electronic device approaches the maximum temperature.

5. The system of claim 4, wherein PFA operations including polling performance data that is being collected in real-time for the electronic device.

6. The system of claim 4, wherein the electronic device is a Hard Disk Drive (HDD).

7. A computer-usable medium embodying computer program code, the computer program code comprising computer executable instructions configured for:
setting a maximum temperature at which an electronic device can operate without damage;
measuring a temperature of the electronic device; and
increasing a frequency of Predictive Failure Analysis (PFA) operations as the temperature of the electronic device approaches the maximum temperature.

8. The computer-usable medium of claim 7, wherein PFA operations including polling performance data that is being collected in real-time for the electronic device.

9. The computer-usable medium of claim 7, wherein the electronic device is a Hard Disk Drive (HDD).
